(19) United States
(12) Patent Application Publication
(10) Pub. No.: US 2010/0061671 A1
(43) Pub. Date: Mar. 11, 2010

(54) Wheel Bearing Apparatus Incorporated With A Wheel Speed Detecting Apparatus

(75) Inventors: Takayuki Norimatsu, Iwata-Shi (JP); Yujiro Ono, Iwata-Shi (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 12/618,845

(22) Filed: Nov. 16, 2009

Related U.S. Application Data
(63) Continuation of application No. PCT/JP2008/001215, filed on May 15, 2008.

(30) Foreign Application Priority Data
May 16, 2007 (JP) 2007-130144
Jul. 30, 2007 (JP) 2007-197136
Aug. 24, 2007 (JP) 2007-217798

(51) Int. Cl. F16C 41/00

(52) U.S. Cl. 384/448

(57) ABSTRACT

A wheel bearing apparatus incorporating a wheel speed detecting apparatus has an outer member, inner member and double row rolling elements rollably contained between the inner and outer raceway surfaces of the inner and outer members. Seals are mounted in annular openings formed between the outer member and the inner member. An annular sensor holder, a steel base, and a magnetic encoder integrally adhered to the base are coupled with the inner and outer members. A slinger is positioned on the inner ring so that an axial gap is formed between the base and the slinger.

### CROSS-REFERENCE TO RELATED APPLICATIONS

This application is a continuation of International Application No. PCT/JP2008/001215, filed May 15, 2008, which claims priority to Japanese Application Nos. 2007-130144, filed May 16, 2007; 2007-197136, filed Jul. 30, 2007; and 2007-217798, filed Aug. 24, 2007. The disclosures of the above applications are incorporated herein by reference.

### FIELD

The present disclosure relates to a wheel bearing apparatus incorporated with a wheel speed detecting apparatus to rotationally support a wheel of an automobile, etc.

### BACKGROUND

It is generally known that a wheel bearing apparatus incorporating a wheel speed detecting apparatus can support a vehicle wheel relative to suspension apparatus and detect a wheel speed to control the anti-lock braking system (ABS). Such a bearing apparatus generally includes a wheel speed detecting apparatus with a magnetic encoder having magnetic poles alternately arranged along its circumference. It is integrated into a sealing apparatus arranged between inner and outer members that contain rolling elements therebetween. A wheel speed detecting sensor detects the variation in the magnetic poles of the magnetic encoder according to the rotation of wheel.

The wheel speed sensor is usually mounted on a knuckle after the wheel bearing apparatus has been mounted on the knuckle forming a suspension apparatus. Recently, wheel bearing apparatus incorporating a wheel speed detecting apparatus has been proposed where a wheel speed detecting sensor is incorporated in the wheel bearing. This reduces the size of the wheel bearing apparatus as well as eliminates troublesome in air gap adjustment between the wheel speed sensor and the magnetic encoder.

An example of a wheel bearing apparatus incorporating a wheel speed detecting apparatus is shown in FIG. 14. Here the wheel bearing apparatus incorporating the wheel speed detecting apparatus has a sensor holder 52 mounted on the end of the outer member 51. The sensor holder 52 has an annular fitting member 53 and a holding portion 54 joined to the annular fitting member 53. The annular fitting member 53 includes a fitting portion 53a press-fit onto the outer circumference of the outer member 51. A flange portion 53b extends radially inward from the fitting member 53a. A cylindrical portion 53c axially extends from the flange portion 53b. The cylindrical portion 53c is formed with apertures 55 along its circumference. Thus, the synthetic resin holding portion 54 is firmly molded with the cylindrical portion 53c. A wheel speed sensor 57 is embedded in the holding portion 54 so that it is arranged at a position opposite to a magnetic encoder 56 via a predetermined gap between the two.

A seal 58 includes a first and second annular sealing plates 60, 61. Each plate has a substantially L shaped cross-section and is mounted on the sensor holder 52 and an inner ring 59, respectively, so that the plates 60, 61 oppose each other. The second sealing plate 61 has a cylindrical portion 61a fit onto the inner ring 59. A standing portion 61b extends radially outward from the cylindrical portion 61a. An annular tongue 61c axially extends from the standing portion 61b. A slight radial gap is formed between the tongue 61c and the cylindrical portion 53c of the annular fitting member 53 to form a labyrinth seal 65.

The first sealing plate 60 includes a metal core 62 fit into the cylindrical portion 53c of the annular fitting member 53. A sealing member 63 is adhered to the metal core 62 via vulcanized adhesion. A side lip 63a, grease lip 63b and a middle lip 63c are integrally formed with the sealing member 63. The side lip 63a is in sliding contact with the standing portion 61b of the second sealing plate 61. The grease lip 63b and the middle lip 63c are in slidingly contact with the cylindrical portion 61a.

A steel base 64 is arranged on the opposite side of the holding portion 54 of the sensor holder 52 from the seal 58. The base 64 has a substantially L shaped cross-section with a cylindrical portion 64a fit onto the inner ring 59. A standing portion 64b extends radially outward from the cylindrical portion 64a. The magnetic encoder 56 is adhered to the inner side surface of the standing portion 64b, via vulcanized adhesion.

In the prior art wheel bearing apparatus incorporating a wheel speed detecting apparatus, the wheel speed sensor 57 is embedded in the sensor holder 52 and the seal 58 is arranged at the inner side of the wheel speed sensor 57. Thus, it is possible to prevent entry of foreign matter, such as magnetic powder from the outside, into the gap between the magnetic encoder 56 and the wheel speed sensor 57. Reference Patent Document 1: Japanese Laid-open Patent Publication No. 300289/2005.

In the prior art wheel bearing apparatus incorporating a wheel speed detecting apparatus, the seal 58 is finally mounted after the base 64, having the magnetic encoder 56, has been firstly fit onto the inner ring 59 and the sensor holder 52 has been mounted onto the outer member 51. However, it is believed in this case that the cylindrical portion 61a of the second sealing plate 61 would abut against the cylindrical portion 64a of the base 64 and thus displace the base 64. Accordingly the air gap (A) between the magnetic encoder 56 and the wheel speed sensor 57 is increased. Thus, it is believed that the detecting accuracy would be detracted due to a reduction in the line of magnetic force from the magnetic encoder.

In such a case, it is possible to solve this problem by strictly limiting the dimensions of the base 64 and the second sealing plate 61 and to set the air gap (A) at a predetermined dimension by controlling the press-fitting strokes, respectively, of the base 64 and the second sealing plate 61. However, this would increase the manufacturing cost of parts of the wheel bearing apparatus and complicates its assembly.

The wheel bearing apparatus incorporating a wheel speed detecting apparatus is repeatedly used under severe conditions such as muddy water, salty water, high temperature, low temperature. Thus, it is desirable that the seal 58 and the base 64, where the magnetic encoder 56 is adhered, resist against these conditions. For example, however, when the base 64 is used under these conditions for a long term, the magnetic encoder 56 would be peeled off from the base 64 and thus the desired magnetic characteristic cannot be satisfied.

The metallic surface of the base 64 has been roughened to increase the gripping power of the adhesive between the metallic base 64 and the elastomeric material of the encoder 56. However, since the base 64 is fit onto the inner ring 59, it is believed that the roughened surface will detract from the sealability of the fit portion between the base 64 and the inner ring 59.

In such a base 64, the surface of the standing portion 64b of the base 64, which the magnetic encoder 56 is adhered, is roughened by shot blasting. In this case, it is required to perform pin-point projection of the shot blasting medium (abrasives) by controlling the motion of a nozzle of a blasting machine to prevent the medium from being projected onto the surface of the cylindrical portion 64a of the base 64 forming the fitting surface to the inner ring 59. This increases the steps of manufacture and management and thus increases manufacturing costs.

The sensor holder 52 is mounted on the outer member 51 at a predetermined circumferential position of the outer member 51. However, it is believed that the annular fitting member 53 would be press-fit onto the outer member 51 at an erroneous circumferential position of the outer member 51. This causes erroneous positioning of the holding portion 54 integrated with the annular fitting member 53. Thus, the length of a harness of the wheel speed sensor 57 would be insufficient after the wheel bearing apparatus has been assembled. Accordingly, the harness of the wheel speed sensor would sometimes be broken during a long term use. Thus, it is difficult to keep the reliability of the wheel speed detection.

### SUMMARY

It is, therefore, an object of the present disclosure to provide a wheel bearing apparatus incorporating a wheel speed detecting apparatus that can improve the detection accuracy as well as reliability. Additionally, it can be manufactured in a compact size and at a low cost.

It is another object to provide a wheel bearing apparatus incorporating a wheel speed detecting apparatus that improves the workability and assembly accuracy. Also, it prevents entry of foreign matter into the detecting portion. Thus, it improves durability and reliability.

To achieve the above mentioned objects, a wheel bearing apparatus incorporating a wheel speed detecting apparatus comprises an outer member formed with a body mounting flange on its outer circumference. The body mounting flange is to be mounted on a suspension apparatus of a vehicle. The inner circumference of the outer member has double row outer raceway surfaces. An inner member includes a wheel hub and at least one inner ring. The wheel hub is integrally formed at one end with a wheel mounting flange. A cylindrical portion axially extends from the wheel mounting flange. The inner ring is press-fit onto the cylindrical portion of the wheel hub. The wheel hub and the inner ring are formed with double row inner raceway surfaces on their outer circumferences. The double row inner raceway surfaces oppose the double row outer raceway surfaces. Double row rolling elements are rollably contained between the inner and outer raceway surfaces. Seals are mounted in annular openings formed between the outer member and the inner member. An annular sensor holder is mounted on an inner side end portion of the outer member. A steel base, with a substantially L shaped cross-section, is fit onto the inner ring. A magnetic encoder is integrally adhered to the base. The magnetic encoder is formed so that its circumferential characteristic alternately and equidistantly vary. The sensor holder includes a steel annular fitting member and a synthetic resin holding portion integrally molded onto the annular fitting member. A wheel speed sensor is embedded in the resin. The annular fitting member includes a cylindrical fitting portion press-fit onto the outer circumference of the outer member. A fitting member flange portion is adapted to be in close contact with the end face of the outer member. A fitting member bottom portion axially extends from the flange portion. An inner side seal of the seals includes an annular sealing plate and a slinger. Each one has a substantially L shaped cross-section and is mounted between the bottom portion and the inner ring so that they oppose each other. The inner side seal and the magnetic encoder are arranged to sandwich the holding portion of the sensor holder. The magnetic encoder is arranged to oppose the wheel speed sensor via an axial gap. The slinger is positioned on the inner ring so that an axial gap is formed between the base and the slinger.

In the wheel bearing apparatus incorporating a wheel speed detecting apparatus, the slinger is positioned on the inner ring so that an axial gap is formed between the base and the slinger. Thus, it is possible to prevent a shift of the base otherwise caused by abutment of the slinger against the base during assembly of the seal. Thus, this prevents a variation of the air gap between the magnetic encoder and the wheel speed sensor. Accordingly, it is possible to set the air gap at a predetermined value without strictly limiting the dimension and the press-fitting stroke of the base and the slinger. Thus, this provides a wheel bearing apparatus incorporating with a wheel speed detecting apparatus that has a simple structure, high detecting accuracy, reliability and can be manufactured at a low cost.

The inner circumference of the inner side end of the outer member is formed with a circumferential recess where the base is received. This enables the standing portion of the base to extend into the recess beyond the end face of the outer member and be contained in the recess. This also enables a shift of the axial position of the sensor holder toward the outer side direction. Thus, this reduces the axial size of the wheel bearing apparatus.

The base is formed from a ferromagnetic steel plate. The magnetic encoder is formed as a rotary encoder made from an elastomer mingled with magnetic powder and magnetized with N and S poles alternately arranged in a circumferential direction. This makes it possible to strengthen the output signal of the magnetic encoder and keep stable detecting accuracy.

The sealing plate includes a metal core fit into the bottom portion of the annular fitting member. A sealing member is adhered to the metal core. It has an integrally formed side lip and radial lips. The slinger includes a standing portion and a cylindrical portion fit onto the inner ring. The side lip slidingly contacts the standing portion. The radial lips slidingly contact the cylindrical portion. This makes it possible to prevent entry of foreign matters, such as dusts and magnetic powder, into the detecting portion between the magnetic encoder and the wheel speed sensor.

An annular tongue axially projects from the tip end of the standing portion. The tongue opposes the bottom portion of the annular fitting member, via a slight gap, to form a labyrinth seal. This makes it possible to improve the sealability of the seal. Thus, this improves the reliability of the detection of wheel speed.

A turn-up is formed on a front open end of the fitting portion of the annular fitting member. It is formed by a pressing process by folding the front open end radially outward and then rearward. This makes it possible to increase the rigidity of the fitting portion of the annular fitting member. Thus, this prevents flare-deformation of the fitting portion during press-fitting as well as slipping-out and circumferential shifting of the fitting portion due to vibration and shocks during running of the vehicle. Accordingly, this improves the reliability of wheel speed detection for a long term.

The base includes a cylindrical portion fit onto the inner ring. A standing portion extends radially outward from the cylindrical portion. The magnetic encoder is adhered to the inner side surface of the standing portion. The surface of the standing portion where the magnetic encoder is adhered remains with its original surface roughness of a blank steel plate without being roughened. This makes it possible to obtain a desirable adhesive strength between the standing portion of the base and the magnetic encoder even if the wheel bearing is used under severe conditions such as muddy water, salty water, high temperature, low temperature, etc. This realizes low cost manufacturing of the wheel bearing apparatus by eliminating the surface roughening step, such as shot blasting. The surface roughness of the base is set within a range Ra 0.2˜0.6.

The annular fitting member is surface roughened to have a surface roughness of Ra 0.8 or more. This makes it possible to increase irregular portions on the surface as compared with a no-roughened surface. Thus, this improves the gripping power of the adhesive between the annular fitting member and the holding portion of the sensor holder. Accordingly, this prevents peeling off of the holding portion from the annular fitting member. Thus, this provides desirable wheel speed detection while keeping the air gap between the magnetic encoder and the wheel speed sensor.

The holding portion is made of a non-magnetic synthetic resin mingled with fiber reinforcements. This improves the strength and durability for a long term without any influence on the sensitivity of the wheel speed sensor.

The holding portion is arranged at a position higher than the horizontal position of the annular fitting member. A harness of the wheel speed detecting sensor is arranged so that it extends tangentially to the holding portion. This makes it possible to discharge foreign matter, such as muddy water, that would enter into the sensor holder toward its bottom as well as improve workability during assembly with the surroundings of the harness being simplified.

A positioning mark is formed on the end face of the outer member. Another positioning mark is formed on the sensor holder at a position corresponding to the wheel speed sensor. The sensor holder is mounted on the outer member by aligning the marks with each other. This makes it possible to mount the sensor holder with high accuracy relative to the outer member, via visual observation. Thus, this improves the workability during assembly and reliability of the wheel bearing assembly.

The positioning mark of the outer member is formed by laser processing or painting. The positioning mark of the sensor holder is formed by paint or indent. The marks are formed on the outer member and the sensor holder in the same direction when they are viewed from an upper or lateral direction, respectively. This makes it possible to mount the sensor holder with high accuracy relative to the outer member via visual observation. Thus, this improves the workability during assembly and reliability of the wheel bearing assembly.

The wheel bearing apparatus incorporating a wheel speed detecting apparatus comprises an outer member with a body mounting flange formed on its outer circumference. The body mounting flange is to be mounted on a suspension apparatus of a vehicle. The inner circumference of the outer member includes double row outer raceway surfaces. An inner member includes a wheel hub and at least one inner ring. The wheel hub is integrally formed at one end with a wheel mounting flange. A cylindrical portion axially extends from the wheel mounting flange. The inner ring is press-fit onto the cylindrical portion of the wheel hub. The wheel hub and the inner ring are formed with inner raceway surfaces on their outer circumferences. The double row inner raceway surfaces oppose the double row outer raceway surfaces. Double row rolling elements are rollably contained between the inner and outer raceway surfaces. Seals are mounted in annular openings formed between the outer member and the inner member. An annular sensor holder is mounted on an inner side end portion of the outer member. A steel base, having a substantially L shaped cross-section, is fit onto the inner ring. A magnetic encoder is integrally adhered to the base. The magnetic encoder is formed so that its circumferential characteristic alternately and equidistantly vary. The sensor holder includes a steel annular fitting member and a synthetic resin holding portion integrally molded on the annular fitting member. A wheel speed sensor is embedded in the resin. The annular fitting member includes a cylindrical fitting portion press-fit onto the outer circumference of the outer member. A flange portion is adapted to be in close contact with the end face of the outer member. A bottom portion axially extends from the flange portion. An inner side seal of the seals includes an annular sealing plate and a slinger. Each has a substantially L shaped cross-section and are mounted between the bottom portion and the inner ring opposing each other. The inner side seal and the magnetic encoder are arranged to sandwich the holding portion of the sensor holder. The magnetic encoder is arranged to oppose the wheel speed sensor via an axial gap. The slinger is positioned on the inner ring so that an axial gap is formed between the base and the slinger. Thus, it is possible to prevent a shift of the base otherwise caused by abutment of the slinger against it during assembly of the seal. Thus, this prevents variation of the air gap between the magnetic encoder and the wheel speed sensor. Accordingly, it is possible to set the air gap at a predetermined value without strictly limiting the dimension and the press-fitting stroke of the base and the slinger. Thus, this provides a wheel bearing apparatus incorporating a wheel speed detecting apparatus that has a simple structure, high detecting accuracy, reliability and can be manufactured at a low cost.

A wheel bearing apparatus incorporating a wheel speed detecting apparatus comprises an outer member formed with a body mounting flange on its outer circumference. The body mounting flange is to be mounted on a suspension apparatus of a vehicle. The inner circumference of the outer member includes double row outer raceway surfaces. An inner member includes a wheel hub and at least one inner ring. The wheel hub is integrally formed at one end with a wheel mounting flange. The wheel hub outer circumference includes one inner raceway surface corresponding to one of the double row outer raceway surfaces. A cylindrical portion axially extends from the inner raceway surface. The inner ring is press-fit onto the cylindrical portion of the wheel hub. The outer circumference of the inner ring includes the other inner raceway surface that corresponds to the other of the double row outer raceway surfaces. Double row rolling elements are rollably contained between the inner and outer raceway surfaces. Seals are mounted in annular openings formed between the outer member and the inner member. An annular sensor holder is mounted on an inner side end portion of the outer member. A steel base, having a substantially L shaped cross-section, is fit onto the inner ring. A magnetic encoder is integrally adhered to the base. The magnetic encoder is formed from an elastomer mingled with magnetic powder and magnetized with N and S poles alternately arranged in a circumferential direction. The sensor holder includes a steel annular fitting member and a synthetic resin holding portion integrally molded on the annular fitting member. A wheel speed sensor is embedded in the synthetic resin. The annular fitting member includes a cylindrical fitting portion press-fit onto the outer circumference of the outer member. A fitting member flange portion is adapted to be in close contact with the end face of the outer member. A bottom portion axially extends from the flange portion. An inner side seal of the seals includes an annular sealing plate and a slinger. Each has a substantially L shaped cross-section and are mounted between the bottom portion and the inner ring opposing each other. The inner side seal and the magnetic encoder are arranged to sandwich the holding portion of the sensor holder. The magnetic encoder is arranged to oppose the wheel speed sensor, via an axial gap. The inner circumference of the inner side end of the outer member is formed with a circumferential recess where the base is received. The slinger is positioned on the inner ring so that an axial gap is formed between the base and the slinger.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal-section view of a first embodiment of a wheel bearing apparatus incorporating a wheel speed detecting apparatus.

FIG. 2 is a partially enlarged view of FIG. 1.

FIG. 3 is a partially enlarged view of a modification of FIG. 2.

FIG. 4 is a longitudinal-section view of a second embodiment of a wheel bearing apparatus incorporating a wheel speed detecting apparatus.

FIG. 5 is a partially enlarged view of FIG. 4.

FIG. 6 is an explanatory view of a shot blasting process of an annular fitting member.

FIG. 7 is a side elevation view of FIG. 4.

FIG. 8 is a longitudinal-section view of a third embodiment of a wheel bearing apparatus incorporating a wheel speed detecting apparatus.

FIG. 9 is a side elevation view of a wheel bearing apparatus before a sensor holder is mounted with it.

FIG. 10 is a side elevation view of FIG. 8.

FIG. 11 is a front elevation view of a wheel bearing apparatus before a sensor holder is mounted with it, which is a modification of FIG. 9.

FIG. 12 is a front elevation view of a wheel bearing apparatus after a sensor holder of FIG. 11 is mounted with it.

FIG. 13(a) is a partially enlarged view of an assembled condition of FIG. 12.

FIG. 13(b) is a partially enlarged view of a modification of FIG. 13(a).

FIG. 14 is a partially enlarged view of a prior art wheel bearing apparatus incorporating a wheel speed detecting apparatus.

### DETAILED DESCRIPTION

A first embodiment of the present disclosure will be described with reference to accompanied drawings.

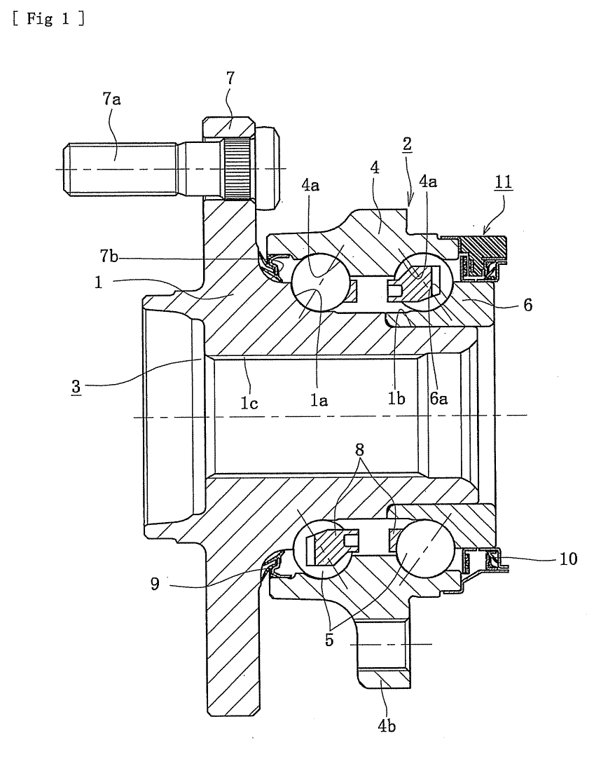

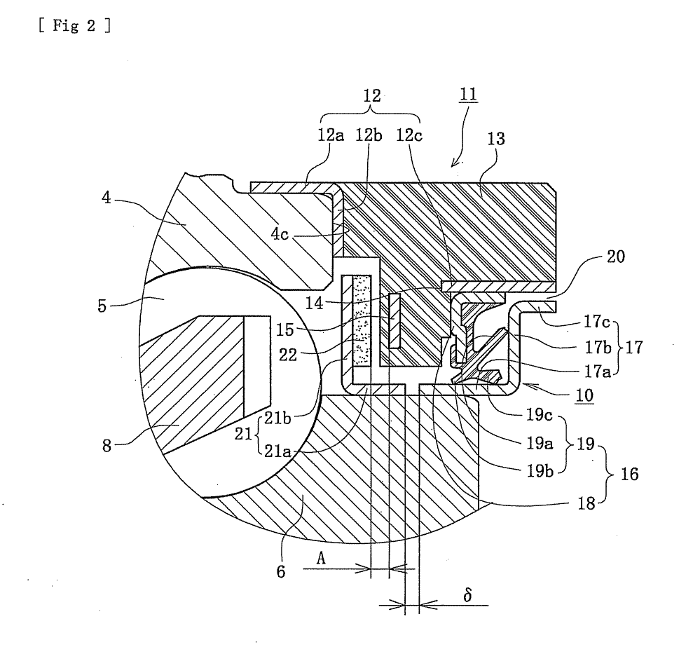

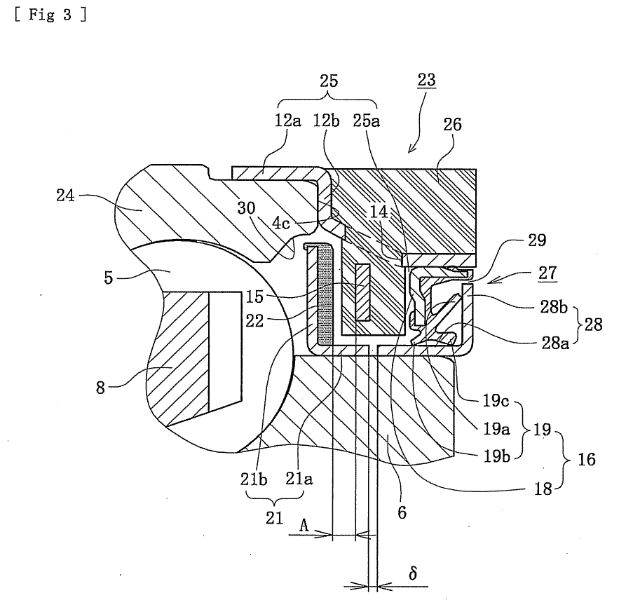

FIG. 1 is a longitudinal-section view of a first embodiment of a wheel bearing apparatus incorporating a wheel speed detecting apparatus. FIG. 2 is a partially enlarged view of FIG. 1. FIG. 3 is a partially enlarged view showing a modification of FIG. 2. In the description below, an outer side of a bearing apparatus, when it is mounted on a vehicle, is referred to as the “outer side” (the left side in a drawing). An inner side of a bearing apparatus, when it is mounted on a vehicle, is referred to as the “inner side” (the right side in a drawing).

The wheel bearing apparatus incorporating a wheel speed detecting apparatus is for a driving wheel that includes a wheel hub 1 and a double row rolling bearing 2. They are formed as a unit arrangement and thus are a so-called “third generation” structure.

The double row rolling bearing 2 includes an outer member 4, an inner member 3, and double row rolling elements (balls) 5 and 5. The outer member 4 is integrally formed with a body mounting flange 4b that is to be mounted on a knuckle (not shown) of a vehicle. Also, the outer member's inner circumference includes double row outer raceway surfaces 4a, 4a. The outer member 4 is made of medium high carbon steel including carbon of 0.40˜0.80% by weight. The double row outer raceway surfaces 4a and 4a are hardened by high frequency induction quenching to have a surface hardness of 58˜64 HRC.

The inner member 3 includes the wheel hub 1 and an inner ring 6 press-fit onto the wheel hub 1. The wheel hub 1 is integrally formed with a wheel mounting flange 7. The flange 7 mounts a wheel (not shown) at its outer side. Hub bolts 7a are secured on the flange 7 at circumferentially equidistant positions. The outer circumferential surface of the wheel hub 1 is formed with one inner raceway surface 1a that corresponds to one (outer side) of the double row outer raceway surfaces 4a and 4a. A cylindrical portion 1b extends axially from the inner raceway surface 1a. The wheel hub 1 is formed with a serration (or spline) 1c on its inner circumference for torque transmission purposes. The inner ring 6 is press-fit onto the cylindrical portion 1b. The inner ring's outer circumference includes the other inner raceway surface 6a that corresponds to the other (inner side) of the double row outer raceway surfaces 4a and 4a.

The wheel hub 1 is made of medium high carbon steel such as S53C including carbon of 0.40˜0.80% by weight. It is formed with a hardened layer with a surface hardness of 58˜64 HRC. The hardened layer is formed by high frequency induction hardening in a region from the seal land portion 7b, that the outer side seal 9 slidingly contacts, to the cylindrical portion 1b, via the inner raceway surface 1a. Thus, it is possible not only to improve the wear resistance of the seal land portion 7b forming the base of the wheel mount flange 7 but to provide a sufficient mechanical strength against the rotary bending load applied to the wheel mount flange 7. Thus, this improves the anti-fretting property and the durability of the wheel hub 1.

The double row rolling elements 5 and 5 are contained between the outer member outer raceway surfaces 4a and 4a and the oppositely arranged inner raceway surfaces 1a and 6a. The rolling elements 5, 5 are rollably held by cages 8, 8.

Seals 9, 10 are arranged at both ends of the outer member 4 to prevent leakage of grease contained within the bearing as well as the entry of rain water or dusts into the bearing. The outer side seal 9 is formed as an integrated seal having a plurality (three in this example) of sealing lips in sliding contact with the seal land portion 7b of the wheel hub 1. An inner side seal 10, described below is formed as a composite seal, such as a so-called “high pack seal”, where an annular sealing plate 16 and slinger 17 are oppositely arranged.

In this embodiment, an annular sensor holder 11 is mounted on the inner side end of the outer member 4 as shown in an enlarged view of FIG. 2. The sensor holder 11 includes an annular fitting member 12 and a holding portion 13, joined to the annular fitting member 12. The annular fitting member 12 is formed with a generally annular configuration. The annular fitting member 12 includes a cylindrical fitting portion 12a press-fit onto the outer circumference of the outer member 4. A flange portion 12b extends radially inward from the fitting portion 12a. A bottom portion 12c axially extends from the flange portion 12b. The annular fitting member 12 is made by press-forming an austenitic stainless steel sheet (JIS SUS 304 etc.) or preserved cold rolled sheet (JIS SPCC etc.). The bottom portion 12c is formed with apertures 14 along its circumferential direction. The holding portion 13 is integrally molded from synthetic resin with the bottom portion 12c. The sensor holder 11 is press-fit onto the end portion of the outer member 4 with the flange portion 12b in close contact against the end face 4c of the outer member 4.

The holding portion 13 is made of non-magnetic resin material such as polyphenylene sulfide (PPS). It is embedded with a wheel speed sensor 15. The wheel speed sensor 15 is arranged opposite to a magnetic encoder 22, described below, via a predetermined axial gap (air gap). The wheel speed sensor 15 includes a magnetic detecting element and an IC. The magnetic detecting element may be a Hall effect element, magnetic resistance element (MR element) etc. to change its characteristics in accordance with the flow direction of magnetic flux. The IC is incorporated with a wave forming circuit to rectify the output wave form of the magnetic detecting element. This detects the wheel speed with a high reliability and at a low cost. The holding portion 13 may be formed by injectable synthetic resins such as polyamide (PA) 66, polybutylene terephthalate (PBT) etc. other than PPS.

The inner side seal 10 includes an annular sealing plate 16, with a substantially L shaped cross-section, and a slinger 17. The seal 10 is mounted in an annular opening formed between the bottom portion 12c of the annular fitting member 12 and the inner ring 6. The sealing plate 16 includes a metal core 18 fit into the bottom portion 12c of the annular fitting member 12. A sealing member 19 is integrally adhered to the metal core 18, via vulcanized adhesion.

The metal core 18 is made by press-forming an austenitic stainless steel sheet (JIS SUS 304 etc.) or preserved cold rolled sheet (JIS SPCC etc.). It is press-formed to have a substantially L shaped cross-section. The sealing member 19 is made of an elastomer such as synthetic rubber. The sealing member 19 includes an integrally formed side lip 19a, grease lip 19b and a medium lip 19c.

The slinger 17 includes a cylindrical portion 17a, standing portion 17b and tongue 17c. The cylindrical portion 17a is fit onto the inner ring 6. The standing portion 17b extends radially outward from the cylindrical portion 17a. The tongue 17c axially projects from the tip end of the standing portion 17b. A labyrinth seal 20 is formed between the tongue 17c and the bottom portion 12c of the annular fitting member by a slight radial gap between the two. The slinger 17 is made by press-forming an austenitic stainless steel sheet (JIS SUS 304 etc.) or preserved cold rolled sheet (JIS SPCC etc.). The side lip 19a slidingly contacts the standing portion 17b of the slinger 17. The grease lip 19b and the medium lip 19c slidingly contact the cylindrical portion 17a of the slinger 17.

A base 21 with a magnetic encoder 22 is arranged on the ring 6 on an opposite side (outer side) of the holding portion 13 of the sensor holder 11 sandwiching the holding portion 13 between the base 21 and the seal 10. The base 21 includes a cylindrical portion 21a fit onto the inner ring 6. A standing portion 21b extends radially outward from the cylindrical portion 21a. The base 21 has a substantially L shaped cross-section. The magnetic encoder 22, of an elastomer such as rubber with mingled magnetic powder such as ferrite, is adhered to the inner side surface of the standing portion 21b, via vulcanized adhesion. The magnetic encoder 22 has N and S poles alternately arranged along its circumference direction. The magnetic encoder forms a rotary encoder to detect the wheel rotational speed. This, in cooperation with the base 21 of ferromagnetic steel, strengthens the output signal and assures a stable detecting accuracy.

According to the present disclosure, the wheel speed sensor 15 is embedded in the sensor holder 11. The seal 10 is arranged at the inner side of the wheel speed sensor 15. Also, the labyrinth seal 20 is arranged at the inner side of the seal 10. Thus, it is possible to surely prevent the entry of foreign matter, such as dusts or magnetic powder, into a space between the magnetic encoder 22 and the detecting portion of the wheel speed sensor 15 from the outside of the bearing apparatus. The entry is prevented under conditions including transportation of the wheel bearing apparatus to automobile manufacturers, and where a constant velocity universal joint (not shown) is connected to the wheel bearing apparatus. Thus, it is possible to improve the reliability of the detection of the wheel speed. Accordingly, it is also possible to reduce the radial size of the wheel bearing apparatus and to simplify the structure of the wheel speed sensor 15 and its surroundings (associated parts). Thus, this further improves the workability during assembly.

In this embodiment, assembly of the wheel speed detecting apparatus will be carried out as follows. The base 21, where the magnetic encoder 22 is adhered, is previously fit onto the inner ring 6 and secured in a predetermined position. The seal 10 is mounted after the sensor holder 11 has been mounted onto the outer member 4. The slinger 17 is secured onto the inner ring 6 at a position so that a predetermined axial gap “δ” is formed between the cylindrical portion 17a of the slinger 17 and the cylindrical portion 21a of the base 21. This prevents shifting of the base 21 that would be otherwise caused by abutment of the cylindrical portion 17a of the slinger 17 against the cylindrical portion 21a of the base 21. Thus, this prevents variations in the air gap “A” between the magnetic encoder 22 and the wheel speed sensor 15. Accordingly, it is possible to set the air gap “A” at a predetermined value without strictly limiting the dimension and the press-fitting stroke of the base 21 and the slinger 17. Thus, this provides a wheel bearing apparatus incorporating a wheel speed detecting apparatus that has a simple structure, high detecting accuracy, reliability and can be manufactured at a low cost.

Although it is shown in this embodiment as an active type wheel speed detecting apparatus including the magnetic encoder 22 and the wheel speed sensor 15 with the magnetic detecting elements such as Hall effect elements, it is possible to use a passive type wheel speed detecting apparatus comprising gears, magnets and wound annular coils.

FIG. 3 is a modification of the wheel speed detecting apparatus (FIG. 2). The same reference numerals are also used in this modification to designate the same portions, same parts or same functions as those in the first embodiment.

An annular sensor holder 23 is mounted on an inner side end of the outer member 24. This sensor holder 23 includes an annular fitting member 25 and a holding portion 26 joined to the annular fitting member 25. The annular fitting member 25 has a generally annular configuration. It includes a cylindrical fitting portion 12a, press-fit onto the outer circumference of the outer member 24, a flange portion 12b, that extends radially inward from the fitting portion 12a, and a bottom portion 25a, that axially extends from the flange portion 12b. The annular fitting member 25 is made by press-forming an austenitic stainless steel sheet (JIS SUS 304 etc.) or preserved cold rolled sheet (JIS SPCC etc.). The bottom portion 25a is formed with apertures 14 along its circumferential direction. The synthetic resin holding portion 26 is integrally molded with the fitting member 25.

The inner side seal 27 includes an annular sealing plate 16, having a substantially L shaped cross-section, and a slinger 28. The seal 27 is mounted in an annular opening formed between the bottom portion 25a of the annular fitting member 25 and the inner ring 6. The slinger 28 includes a cylindrical portion 28a, fit onto the inner ring 6, and a standing portion 28b, that extends radially outward from the cylindrical portion 28a. A labyrinth seal 29 is formed between an outer circumferential edge of the standing portion 28b and the metal core 18 of the sealing plate 16 by a slight radial gap between the two. The slinger 28 is made by press-forming an austenitic stainless steel sheet (JIS SUS 304 etc.) or preserved cold rolled sheet (JIS SPCC etc.).

Similar to the first embodiment, a base 21, where the magnetic encoder 22 is adhered, is previously fit onto the inner ring 6 and secured in a predetermined position. The seal 27 is mounted after the sensor holder 23 has been mounted onto the outer member 24. The slinger 28 is secured onto the inner ring 6 at a position so that a predetermined axial gap “6” is formed between the cylindrical portion 28a of the slinger 28 and the cylindrical portion 21a of the base 21.

In this modification, the inner circumference of the inner side end of the outer member 24 is formed with a circumferential recess 30. The standing portion 21b of the base 21 can extend into the recess 30 beyond the end face of the outer member 24 and be contained in the recess 30. This also enables to shift the axial position of the sensor holder 23 toward the outer side direction. Thus, this reduces the axial size of the wheel bearing apparatus incorporating a wheel speed detecting apparatus.

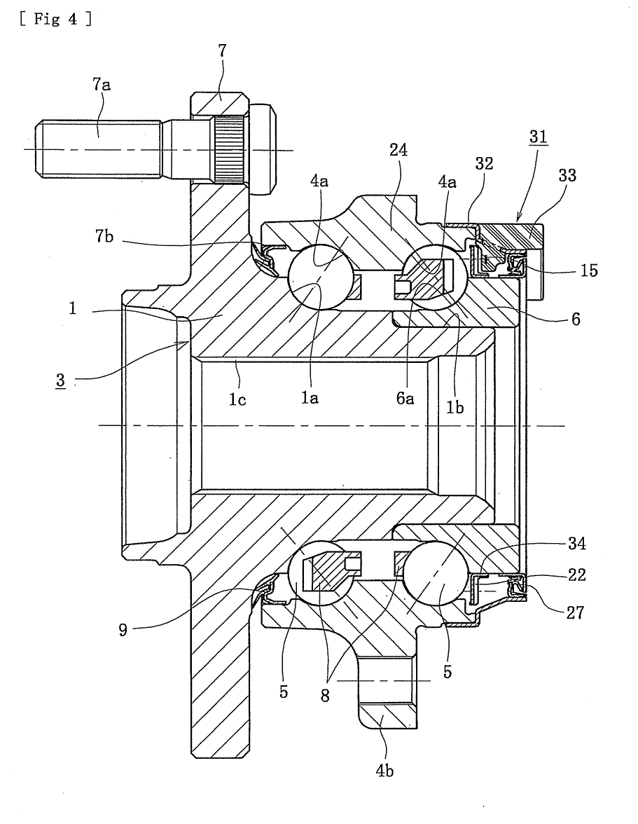

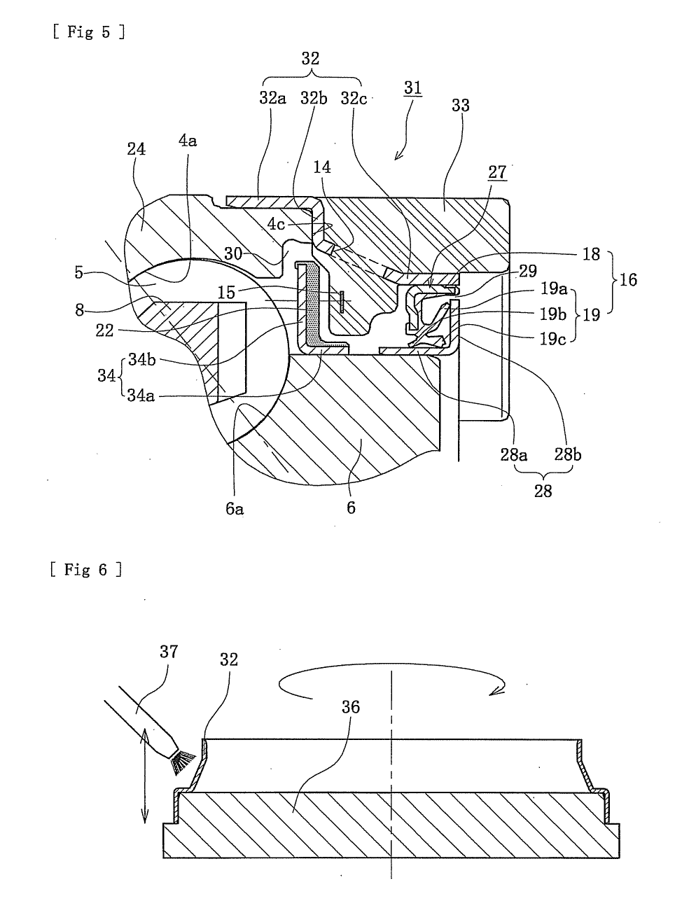

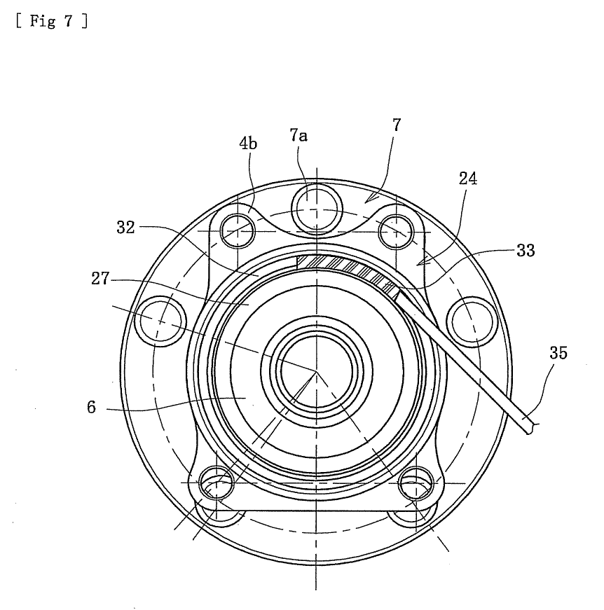

FIG. 4 is a longitudinal-section view of a second embodiment of a wheel bearing apparatus incorporating with a wheel speed detecting apparatus. FIG. 5 is a partially enlarged view of FIG. 4. FIG. 6 is an explanatory view illustrating a shot blasting process of an annular fitting member. FIG. 7 is a side elevation view of FIG. 4. The second embodiment is different from the first embodiment (FIG. 3) only in the structure of the sensor holder. Accordingly, the same reference numerals are also used in this embodiment to designate the same portions, same parts or same functions as those in the previous embodiment and modification.

In this embodiment a sensor holder 31 is mounted on the inner side end of the outer member 24. As shown in an enlarged view of FIG. 5, the sensor holder 31 includes an annular fitting member 32 and a holding portion 33 joined to the annular fitting member 32. The annular fitting member 32 is formed with a generally annular configuration. It includes a cylindrical fitting portion 32a, press-fit onto the outer circumference of the outer member 24, a flange portion 32b, that extends radially inward from the fitting portion 32a and adapted to be in close contact against the end face 4c of the outer member 24, and a bottom portion 32c, that axially extends from the flange portion 32b.

The annular fitting member 32 is made by press-forming an austenitic stainless steel sheet (JIS SUS 304 etc.) or preserved cold rolled sheet (JIS SPCC etc.). The bottom portion 32c is formed with a plurality of apertures 14 along its circumferential direction. The synthetic resin holding portion 33 is integrally molded with the fitting member 32.

The holding portion 33 is made by injection molding a non-magnetic resin material such as polyphenylene sulfide (PPS) with a mingled fiber reinforcement such as glass fibers (GF). The wheel speed sensor 15 is embedded in the holding portion 33. This improves the anti-corrosion property, strength and durability for a long term without detracting from the sensitivity of the wheel speed sensor 15. The holding portion 33 may be formed by injectable synthetic resins such as polyamide (PA) 66, polybutylene terephthalate (PBT) etc. other than PPS.

The magnetic encoder 22 is adhered to a base 34. The base 34 is adapted to be press-fit onto the inner ring 6. The base 34 is arranged on the inner ring such that the holding portion 33 is sandwiched between the base 34 and seal 27. The base 34 opposes the wheel speed detecting sensor 15, via a predetermined axial gap (air gap). The base 34 is made by press-forming a ferromagnetic steel plate such as ferritic stainless steel (JIS SUS 430 etc.) or preserved cold rolled sheet (JIS SPCC etc.). The base 34 has a generally annular configuration with a substantially L shaped cross-section. The base 34 has a cylindrical portion 34a fit onto the inner ring 6 and a standing portion 34b that extends radially outward from the cylindrical portion 34a.

The phase arrangement of the wheel speed sensor 15, i.e. the phase arrangement of the holding portion 33, is set at a radially upper half (a vertically upper position in a drawing) from the horizontal position of the annular fitting member 32. A harness 35 is tangentially connected to the holding portion 33 as shown in FIG. 7. Accordingly, it is possible to discharge rain or muddy water that enters into the sensor holder 31 from a bottom portion of the sensor holder 31. This prevents the foreign matter from staying near the wheel speed sensor 15. Furthermore, surroundings (related parts) of the harness 35 can be simplified. Thus, the workability during assembly of the wheel bearing apparatus can be improved.

The holding portion 33, forming the sensor holder 31, is integrally molded with the annular fitting member 32. A surface of the annular fitting member 32, to be adhered to the synthetic resin forming the holding portion 33, is roughened to have a surface roughness of Ra 0.8 or more. That is, although the blank steel plate forming the annular fitting member 32 usually has a surface roughness in the range of Ra 0.2˜0.6, the blank steel plate is roughened by shot blasting so that it has a surface roughness of Ra 0.8 or more. The character “Ra” is one of the roughness geometrical parameters of JIS (JIS B0601-1994). It is the arithmetical means roughness, a mean value of absolute value deviations from the average line.

The shot blasting is performed as shown in FIG. 6. The annular fitting member 32 is first placed on a turn table 36. It is rotated on the turn table 36 and blasting media, such as steel beads, is shot blasted from a nozzle 37 onto the annular fitting member 32. In this case, the shot blasting is performed under conditions using steel beads with a particle size 20˜100 μm. The blasting duration is about 90 seconds. The blasting pressure is about 1˜3 kg/cm². The nozzle 37 is moved along an arrow as shown in FIG. 6.

The surface of the annular fitting member 32, to be adhered to resin of the holding portion 33, is roughened by shot blasting. The surface roughness is set to Ra 0.8 or more. Irregularities are formed in the contacting area of the adhering surface increasing the contact area. Thus, it is possible to increase the adhesiveness between the adhering surfaces of the annular fitting member 32 and the holding portion 33. Accordingly, it is possible to prevent separation between the surfaces of the annular fitting member 32 and the holding portion 33 for a long term even if the bearing apparatus is exposed to severe circumstances. Thus, this keeps a predetermined air gap between the magnetic encoder 22 and the wheel speed sensor 15 and provides a desired detection of the wheel speed.

Unlike the annular fitting member 32, the adhering surface of the base 34, that the magnetic encoder 22 is adhered via vulcanized adhesion, is not roughened and remained in its original surface roughness of steel plate blank. That is, the surface roughness of the base 34 is set within a range of Ra 0.2˜0.6.

The magnetic encoder 22 is arranged at the inner side of the bearing and sealed from the outer circumstances by the seal 27. Thus, it is possible to use the wheel bearing apparatus under severe conditions, such as muddy water, salty water, high temperature and low temperature. In addition the base 34 can have a desirable adhering strength with the magnetic encoder 22 without performing any surface roughening treatment, such as shot blasting treatment, on the base 34. This reduces the machining steps and thus the manufacturing cost.

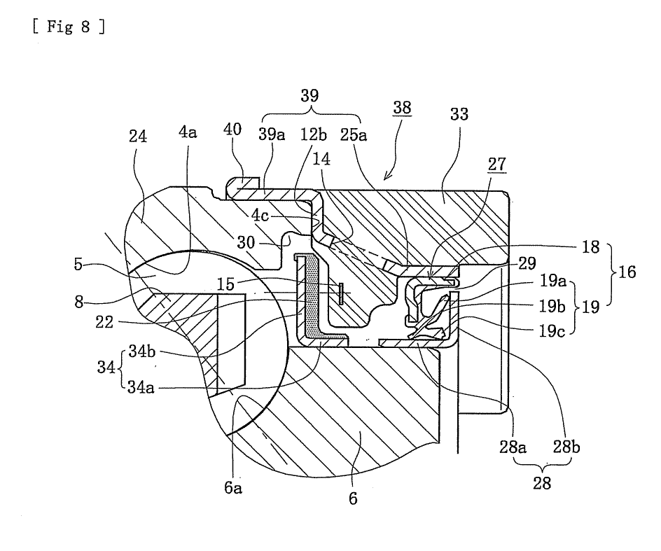

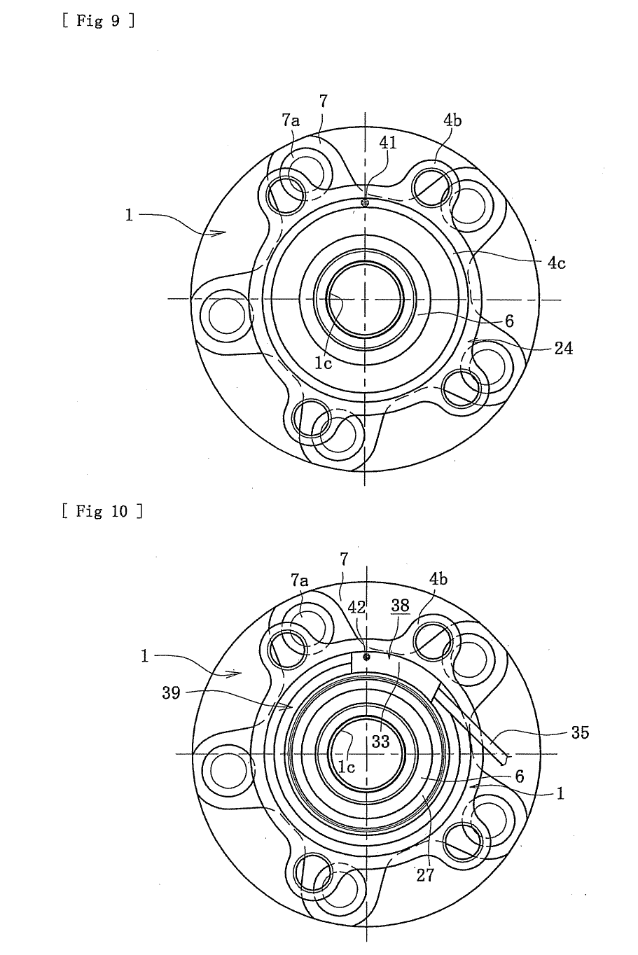

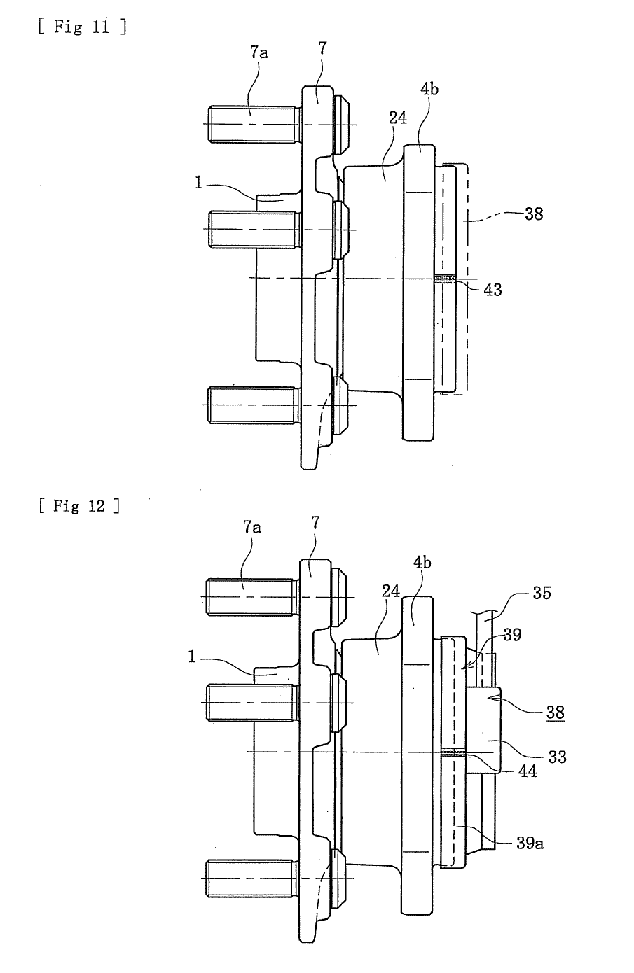

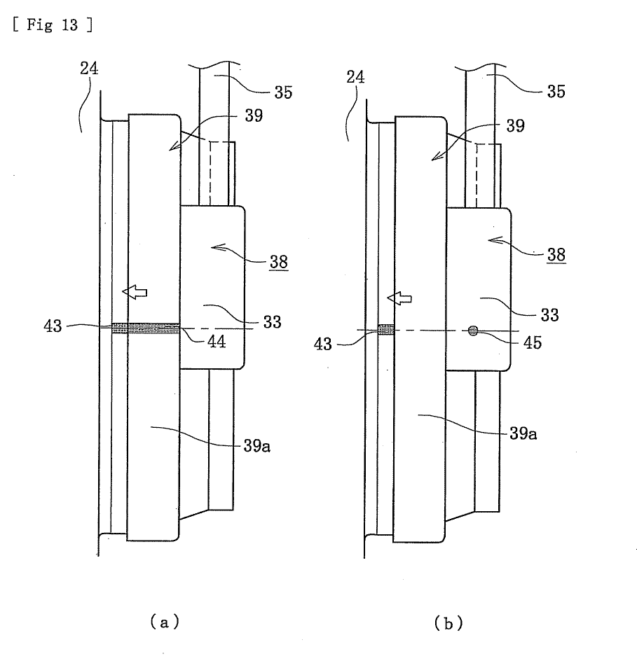

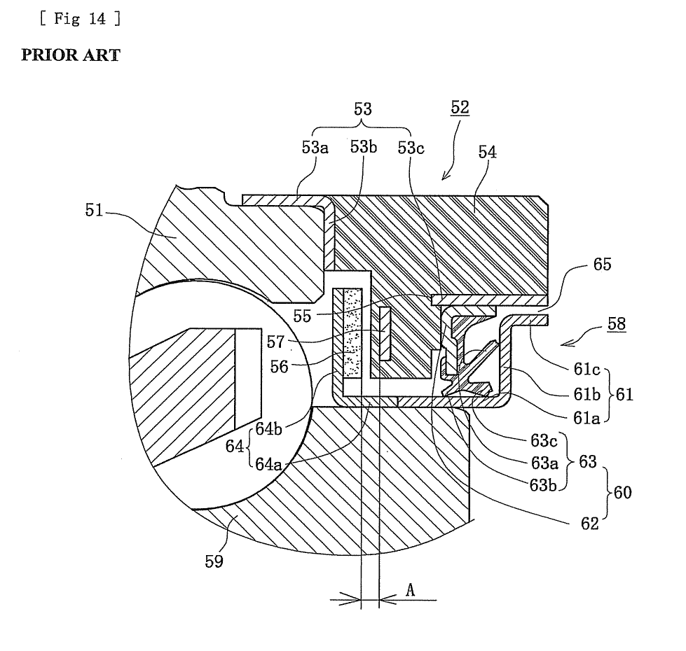

FIG. 8 is a longitudinal-section view of a third embodiment of a wheel bearing apparatus incorporating a wheel speed detecting apparatus. FIG. 9 is a side elevation view of a wheel bearing apparatus before a sensor holder is mounted. FIG. 10 is a side elevation view of FIG. 8. FIG. 11 is a front elevation view of a wheel bearing apparatus before a sensor holder is mounted on it, which is a modification of FIG. 9. FIG. 12 is a front elevation view of a wheel bearing apparatus after a sensor holder of FIG. 11 is mounted on it. FIG. 13(a) is a partially enlarged view of an assembled condition of FIG. 12. FIG. 13(b) is a partially enlarged view of a modification of FIG. 13(a). The third embodiment is different from the first embodiment (FIG. 3) only in the structure of the sensor holder. Accordingly, the same reference numerals are also used in this embodiment to designate the same portions, same parts or same functions as those in the first embodiment.

In this embodiment, a sensor holder 38 is mounted on the inner side end of the outer member 24. The sensor holder 38 includes an annular fitting member 39 and a holding portion 33 joined to the annular fitting member 39. The annular fitting member 39 is formed with a generally annular configuration. The fitting member 39 includes a cylindrical fitting portion 39a, press-fit onto the end portion of the outer member 24, a flange portion 12b, that extends radially inward from the fitting portion 39a, and a bottom portion 25a, that axially extends from the flange portion 12b.

A turn-up 40 is formed on a front open end of the fitting portion 39a of the annular fitting member 39. It is formed by a pressing process by folding the front open end radially outward and then rearward. This makes it possible to increase the rigidity of the fitting portion 39a of the annular fitting member 39. Thus, this prevents flare-deformation of the fitting portion 39a during press-fitting. Additionally, it prevents slipping-out and circumferential shifting of the fitting portion 39a due to vibration and shock during running of the vehicle. Accordingly, this improves the reliability of wheel speed detection for a long term. The annular fitting member 39 is made by press-forming an austenitic stainless steel sheet (JIS SUS 304 etc.) or preserved cold rolled sheet (JIS SPCC etc.).

The phase arrangement of the wheel speed sensor 15, the phase arrangement of the holding portion 33, is set at a radially upper half a vertically upper position in a drawing, preferably a vertically uppermost position) from the horizontal position of the annular fitting member 39. A harness 35 is tangentially connected to the holding portion 33 as shown in FIG. 10. Thus, it is not required to unnecessarily lengthen the harness 35 itself. The harness 35 can be easily taken out radially outward of a knuckle. This improves workability during assembly.

In the third embodiment, a positioning mark 41 is formed on the inner side end face 4c of the outer member 24, as shown in FIG. 9. The mark 41 can be formed as a dot configuration, by laser marking, at the holding portion 33 of the sensor holder 38 and, more particularly at a phase corresponding to the wheel speed sensor 15 embedded in the holding member 33. The mark 41 may be formed by painting other than the laser marking.

A mark 42 is formed, by painting, at a predetermined position on the side face of the holding portion 33 of the sensor holder 38 as shown in FIG. 10. This mark 42 is formed as a dot configuration at a position corresponding to the wheel speed sensor 15. During assembly of the sensor holder 38, it is mounted on the outer member 24 aligning positions of the mark 41 of the outer member 24 with the mark 42 of the holding portion 33. Thus, it is possible, especially during assembling of the wheel bearing apparatus in a vertically laid manner, to accurately mount the sensor holder 38 on the outer member 24 with visual observation of the marks 41, 42 from the same direction (i.e. from above). Thus, it is possible to improve the workability during assembly and to provide a wheel bearing apparatus incorporating with a wheel speed detecting apparatus that has improved reliability. The formation of the positioning mark 42 is not limited to painting and may be performed by indents. In addition, it may be formed simultaneously with formation of the holding member 33.

FIG. 11 shows a modification of the positioning mark. In this modification a mark 43 is formed on the outer circumference of the inner side end of the outer member 24. The mark 43 is formed as a band configuration by laser marking on a portion of the outer member 24 where the annular fitting member 39 of the sensor holder 38 is press-fit at a phase corresponding to the wheel speed sensor 15. The mark 43 may be formed on a portion of the outer circumference of the end of the outer member 24 where the annular fitting member 39 is not press-fit, or on the inner side surface of the body mounting flange 4b.

A mark 44 is formed on the outer circumference of the fitting portion 39a of the annular fitting member 39 of the sensor holder 38. The mark 44 is formed as a band configuration at a position corresponding to the wheel speed sensor 15. The sensor holder 38 is mounted on the outer member 24 by aligning the mark 44 of the annular fitting member 39 with the mark 43 of the outer member 24 as shown in FIG. 13(a). Thus it is possible, especially during assembly of the wheel bearing apparatus in a vertically laid manner, to easily mount the sensor holder 38 on the outer member 24 with visual observation of the marks 43, 44 from the same direction (i.e. from lateral). Thus, it is possible to improve the positioning accuracy of the sensor holder 38 relative to the outer member 24 and to further improve the workability during assembly.

Other form of the marking is shown in FIG. 13(b). In this modification a mark 43 is formed on the outer circumference of the inner side end face of the outer member 24. A corresponding mark 45, in a dot configuration, is formed on the outer circumference of the holding portion 33 of the sensor holder 38. The sensor holder 38 can be mounted on the outer member 24 by aligning the marks 43, 45 with each other. Although not illustrated, the mark 45 may be formed on the side surface of the holding portion 33 of the sensor holder 38 and the configuration of the mark may be formed as a band.

The wheel bearing apparatus incorporating a wheel speed detecting apparatus of the present disclosure can be applied to a wheel bearing apparatus where any type of the wheel speed detecting apparatus is incorporated.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A wheel bearing apparatus incorporating a wheel speed detecting apparatus comprising:
an outer member formed with a body mounting flange on its outer circumference, said body mounting flange to be mounted on a suspension apparatus of a vehicle, said outer member inner circumference including double row outer raceway surfaces;
an inner member including a wheel hub and at least one inner ring, the wheel hub integrally formed at one end with a wheel mounting flange, a cylindrical portion axially extending from the wheel mounting flange, the inner ring being press-fit onto the cylindrical portion of the wheel hub, the wheel hub and the inner ring including double row inner raceway surface on their outer circumferences, said double row inner raceway surfaces opposing the double row outer raceway surfaces;
double row rolling elements are rollably contained between the inner and outer raceway surfaces;
seals are mounted in annular openings formed between the outer member and the inner member;
an annular sensor holder is mounted on an inner side end portion of the outer member;
a steel base, having a substantially L shaped cross-section, is fit onto the inner ring;
a magnetic encoder is integrally adhered to the base, the magnetic encoder is formed so that its circumferential characteristic alternately and equidistantly varies;
said sensor holder including a steel annular fitting member and a synthetic resin holding portion integrally molded on the annular fitting member, a wheel speed sensor embedded in said resin holding portion;
said annular fitting member including an cylindrical fitting portion, press-fit onto the outer circumference of the outer member, a flange portion, adapted to be in close contact with the end face of the outer member, and a bottom portion, axially extending from the flange portion;
an inner side seal of said seals including an annular sealing plate and a slinger, said annular sealing plate and slinger each have a substantially L shaped cross-section and are mounted between the bottom portion and the inner ring opposing each other;
said inner side seal and the magnetic encoder being arranged to sandwich the holding portion of the sensor holder;
said magnetic encoder is arranged to oppose the wheel speed sensor via an axial gap; and
said slinger is positioned on the inner ring so that an axial gap is formed between the base and the slinger.

2. The wheel bearing apparatus incorporating a wheel speed detecting apparatus of claim 1, wherein the inner circumference of the inner side end of the outer member is formed with a circumferential recess where the base is received.

3. The wheel bearing apparatus incorporating a wheel speed detecting apparatus of claim 1, wherein the base is formed of a ferromagnetic steel plate, and the magnetic encoder is formed as a rotary encoder made of a mingled elastomer with magnetic powder and magnetized with N and S poles alternately arranged in a circumferential direction.

4. The wheel bearing apparatus incorporating a wheel speed detecting apparatus of claim 1, wherein the sealing plate includes a metal core fit into the bottom portion of the annular fitting member, a sealing member is adhered to the metal core, the sealing member includes an integrally formed side lip and radial lips, the slinger includes a standing portion and a cylindrical portion fit onto the inner ring, the side lip slidingly contacts the standing portion and the radial lips slidingly contacts the cylindrical portion.

5. The wheel bearing apparatus incorporating a wheel speed detecting apparatus of claim 4, wherein an annular tongue axially projects from the tip end of the standing portion, and the tongue is opposed to the bottom portion of the annular fitting member via a slight gap to form a labyrinth seal.

6. The wheel bearing apparatus incorporating a wheel speed detecting apparatus of claim 1, wherein a turn-up is formed by a pressing process on a front open end of the fitting portion of the annular fitting member by folding the front open end radially outward and then rearward.

7. The wheel bearing apparatus incorporating a wheel speed detecting apparatus of claim 1, wherein the base further comprises a cylindrical portion, fit onto the inner ring, and a standing portion, extending radially outward from the cylindrical portion, wherein the magnetic encoder is adhered to the inner side surface of the standing portion, and the surface of the standing portion where the magnetic encoder is adhered remains as having its original surface roughness of a steel plate blank without being roughened.

8. The wheel bearing apparatus incorporating a wheel speed detecting apparatus of claim 7, wherein the surface roughness of the base is set within a range Ra 0.2˜0.6.

9. The wheel bearing apparatus incorporating a wheel speed detecting apparatus of claim 7, wherein the annular fitting member is surface roughened to have a surface roughness of Ra 0.8 or more.

10. The wheel bearing apparatus incorporating a wheel speed detecting apparatus of claim 1, wherein the holding portion is made of non-magnetic synthetic resin mingled with fiber reinforcements.

11. The wheel bearing apparatus incorporating a wheel speed detecting apparatus of claim 1, wherein the holding portion is arranged at a position higher than the horizontal position of the annular fitting member, and a harness of the wheel speed detecting sensor is arranged so that it extends tangentially to the holding portion.

12. The wheel bearing apparatus incorporating a wheel speed detecting apparatus of claim 1, wherein a positioning mark is formed on the end face of the outer member and another positioning mark is formed on the sensor holder at a position corresponding to the wheel speed sensor, the sensor holder is mounted on the outer member by aligning the marks with each other.

13. The wheel bearing apparatus incorporating a wheel speed detecting apparatus of claim 12, wherein the positioning mark of the outer member is formed by laser processing or painting.

14. The wheel bearing apparatus incorporating a wheel speed detecting apparatus of claim 12, wherein the positioning mark of the sensor holder is formed by paint or indent.

15. The wheel bearing apparatus incorporating a wheel speed detecting apparatus of claim 12, wherein the marks are formed on the outer member and the sensor holder in the same direction when they are viewed from an upper or lateral direction, respectively.
